(19) United States
(12) Patent Application Publication
(10) Pub. No.: US 2017/0061279 A1
(43) Pub. Date: Mar. 2, 2017

(54) UPDATING AN ARTIFICIAL NEURAL NETWORK USING FLEXIBLE FIXED POINT REPRESENTATION

(71) Applicant: Intel Corporation, Santa Clara, CA (US)

(72) Inventors: Andrew Yang, Cupertino, CA (US); Carey Kloss, Los Altos, CA (US); Prashant Arora, Fremont, CA (US); Alex S. Park, San Diego, CA (US); Naveen G. Rao, San Diego, CA (US); Amir Khosrowshahi, Del Mar, CA (US)

(73) Assignee: Intel Corporation, Santa Clara, CA (US)

(21) Appl. No.: 14/597,091

(22) Filed: Jan. 14, 2015

(51) Int. Cl. G06N 3/08; G06N 3/04

(52) U.S. Cl. CPC G06N 3/08; G06N 3/04

(57) ABSTRACT

Updating an artificial neural network is disclosed. A node characteristic is represented using a fixed point node characteristic parameter. A network characteristic is represented using a fixed point network characteristic parameter. The fixed point node characteristic parameter and the fixed point network characteristic parameter are processed to determine a fixed point intermediate parameter having a larger size than either the fixed point node characteristic parameter or the fixed point network characteristic parameter. A value associated with the fixed point intermediate parameter is truncated according to a system truncation schema. The artificial neural network is updated according to the truncated value.

### BACKGROUND OF THE INVENTION

An artificial neural network is a type of computational model that can be used to solve tasks that are difficult to solve using traditional computational models. For example, an artificial neural network can be trained to perform pattern recognition tasks that would be extremely difficult to implement using other traditional programming paradigms. Utilizing an artificial neural network often requires performing calculations and operations to develop, train, and update the artificial neural network. Traditionally, artificial neural networks have been implemented using off-the-shelf computer processors that operate using 32 or 64 bit chunks of data. In order to maintain the high level of precision traditionally thought to be required when performing calculations for the neural network, calculations and operations for the neural network have been performed using floating point numbers encoded within the 32 or 64 bit data chunks provided by the off-the-shelf computer processors. For example, 32 bit floating point numbers encoded in the standard IEEE 754 format are utilized to represent data and perform calculations of an artificial neural network.

However, it is computationally expensive to perform floating point calculations and operations. As larger and more complex artificial neural networks are implemented, it is desirable to reduce their computational complexity to improve speed, power requirements, and other inefficiencies. Additionally, the level of data precision required for certain types of artificial neural networks may be less than what was traditionally thought to be required.

### BRIEF DESCRIPTION OF THE DRAWINGS

Various embodiments of the invention are disclosed in the following detailed description and the accompanying drawings.

FIG. 1 is a block diagram illustrating an embodiment of a system for updating an artificial neural network.

FIG. 2 is a functional diagram illustrating a programmed computer system for updating an artificial neural network in accordance with some embodiments.

FIG. 3 is a flowchart illustrating an embodiment of a process for updating an artificial neural network.

FIG. 4 is an example neural network.

FIG. 5 is a flowchart illustrating an embodiment of a process for processing an instruction.

FIG. 6 is a flowchart illustrating an embodiment of a process for performing a matrix multiplication instruction.

FIG. 7 is a flowchart illustrating an embodiment of a process for performing an addition or subtraction instruction.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Updating an artificial neural network is disclosed. In some embodiments, a node characteristic is represented using a fixed point node parameter and a network characteristic is represented using a fixed point network parameter. For example, an activation value of the artificial neural network is represented as a node characteristic in fixed point number format rather than a floating point number format and a weight value of the artificial neural network is represented as a network characteristic in fixed point number format rather than a floating point number format. The fixed point node parameter and the fixed point network parameter are operated to determine a fixed point intermediate parameter. For example, the fixed point node parameter and the fixed point network parameter are utilized as operands of a calculation operation such as a multiplication and an intermediate result of the operation is stored as the fixed point intermediate parameter. The fixed point intermediate parameter has a larger size then either the fixed point node parameter or the fixed point network parameter. For example, the number of bits utilized to represent either the fixed point node parameter or the fixed point network parameter is smaller than the number of bits utilized to represent the fixed point intermediate parameter. The fixed point intermediate parameter may be larger in size to retain the precision of an intermediate result resulting from a calculation operation.

In some embodiments, a value associated with the fixed point intermediate parameter is truncated and/or rounded according to a flexible system truncation schema. For example, although results of an intermediate calculation operation were stored in a larger bit size parameter to retain precision for intermediate calculation steps, a final result to be provided for an operation (e.g., final result returned by a processor instruction) is truncated to fit within a specified fixed number of standardized bits. Performing the truncation may include rounding the intermediate fixed point parameter to include a specified number of bits after a radix point and another specified number of bits before the radix point. By allowing the number of bits after a radix point of a fixed point number representation to be flexibly specified and defined, a large dynamic range of numbers that are able to be represented may be maintained. The node characteristic or the network characteristic is updated according to the truncated value. For example, during a forward propagation of the neural network, the node characteristic is updated, and during a back propagation of the neural network, the network characteristic is updated.

In some embodiments, the update of the artificial neural network is performed using a processor specifically designed for processing artificial neural networks. For example, a processor instruction specially engineered for the artificial neural network update utilizes processor registers of various sizes to store the fixed point node parameter, fixed point network parameter, and the fixed point intermediate parameter. In some embodiments, the update of the artificial neural network is performed using generic hardware, and software is utilized to perform the neural network update using fixed point representation format operations that can dynamically modify the fixed point format of a result of the operation. In some embodiments, hardware/storage specifically designed to represent data as a two dimensional structure (e.g., matrix) and perform truncation based on the two dimensional structure is utilized.

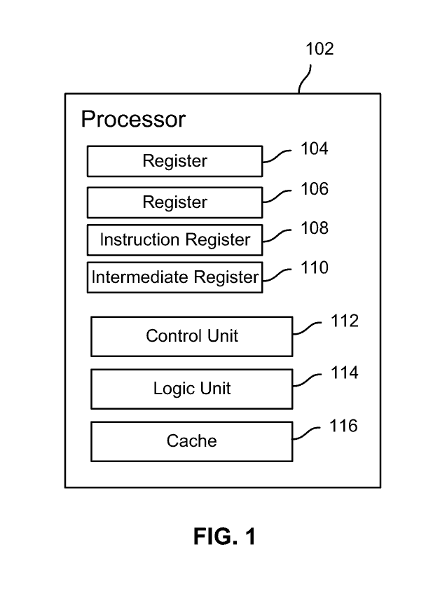

FIG. 1 is a block diagram illustrating an embodiment of a system for updating an artificial neural network. Processor 102 includes register 104, register 106, instruction register 108, intermediate register 110, control unit 112, logic unit 114, and cache 116. In some embodiments, processor 102 is a specialized processor developed to implement an artificial neural network. In some embodiments, processor 102 is a graphics processing unit. In some embodiments, processor 102 is a central processing unit. Instruction register 108 may be loaded with a specialized processor instruction to update an artificial neural network. For example, a processor instruction to perform at least a portion of a forward propagation of the artificial neural network is loaded into instruction register 108. Control unit 112 controls and directs the flow of instructions and data in processor 102. For example, control unit 112 loads instructions to be processed in instruction register 108 and directs flow of data to components to perform the instruction loaded in instruction register 108. Control unit 112 may include decoders and multiplexors.

Cache 116 includes memory storage that can store instructions and data for processor 102. For example, obtaining data from a memory external to processor 102 may take a relatively long time and cache 116 is a smaller, faster memory which stores copies of data processed, to be processed, or likely processed by processor 102 from main memory locations. Cache 116 may include a plurality of cache hierarchies.

Register 104 and register 106 are registers that can store data to be utilized to perform an operation. For example, register 104 and register 106 are faster storages than cache 116 and may be loaded with data from cache 116 that are to be utilized to perform an operation. In one example, an instruction loaded in instruction register 108 may identify register 104 and/or register 106 as including content to be utilized in performing the operation of the instruction. Registers 104 and 106 may be included in a set of a plurality of general purpose registers of processor 102. The size (e.g., number of bits able to be stored) of register 104 and register 106 may be different or same in various different embodiments. In some embodiments, register 104 and register 106 are configured to be able to store two dimensional data (e.g., matrix) and/or other single or multi-dimensional data.

Logic unit 114 performs calculations and operations. For example, logic unit 114 performs a mathematical operation specified by an instruction loaded in instruction register 108. A result of a logic unit 114 is stored in intermediate register 110. For example, a multiplication operation result of multiplying data in register 104 with data in register 106 performed by logic unit 114 is stored in intermediate register 110. In some embodiments, a size of intermediate register 110 is larger than a size of register 104 or a size of register 106. For example, a number of bits that can be stored in intermediate register 110 is larger than the number of bits that can be stored in either register 104 or register 106 to retain intermediate data precision as a result of the operation performed by logic unit 114. In one example, register 104 and register 106 are both 16 bits in size and intermediate register 110 is double (e.g., 32 bits) in size to accommodate the maximum number of bits potentially required to represent a resulting product of multiplying two 16 bit numbers together. The different registers shown in FIG. 1 may be of all the same size or of one or more different sizes.

The contents of processor 102 shown in FIG. 1 have been simplified to illustrate the example. Although single instances of many of the components shown in FIG. 1 have been shown to simplify the diagram, additional instances of any of the components shown in FIG. 1 may exist in processor 102. For example, processor 102 may include a plurality of processor cores each with its own set of different types of registers, control unit, logic unit and cache. Components not shown in FIG. 1 may also exist. For example, common processor components such as buses and other data communication components may exist. The components shown in FIG. 1 may be made of transistors, logic gates, multiplexors, storage cells, etc. In some embodiments, processor 102 is a virtual processor emulated in software.

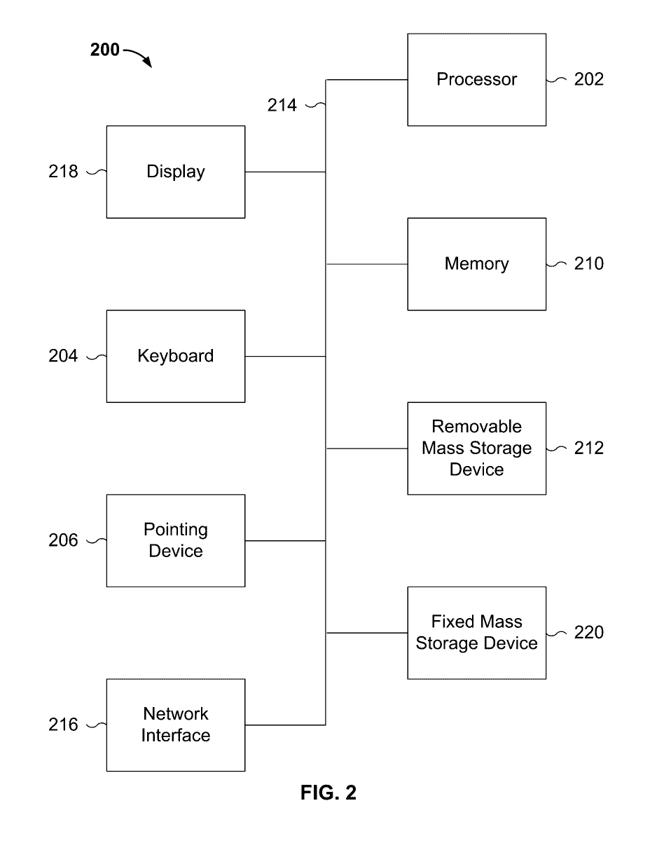

FIG. 2 is a functional diagram illustrating a programmed computer system for updating an artificial neural network in accordance with some embodiments. As will be apparent, other computer system architectures and configurations can be used to update the artificial neural network. Computer system 200, which includes various subsystems as described below, includes at least one microprocessor subsystem (also referred to as a processor or a central processing unit (CPU)) 202. For example, processor 202 can be implemented by a single-chip processor or by multiple processors. In some embodiments, processor 202 is a general purpose digital processor that controls the operation of the computer system 200. In some embodiments, processor 202 includes processor 102 shown in FIG. 1. Using instructions retrieved from memory 210, the processor 202 controls the reception and manipulation of input data, and the output and display of data on output devices (e.g., display 218).

Processor 202 is coupled bi-directionally with memory 210, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 202. Also as is well known in the art, primary storage typically includes basic operating instructions, program code, data, and objects used by the processor 202 to perform its functions (e.g., programmed instructions). For example, memory 210 can include any suitable computer-readable storage media, described below, depending on whether, for example, data access needs to be bi-directional or uni-directional. For example, processor 202 can also directly and very rapidly retrieve and store frequently needed data in a cache memory (not shown).

A removable mass storage device 212 provides additional data storage capacity for the computer system 200, and is coupled either bi-directionally (read/write) or uni-directionally (read only) to processor 202. For example, storage 212 can also include computer-readable media such as magnetic tape, flash memory, PC-CARDS, portable mass storage devices, holographic storage devices, and other storage devices. A fixed mass storage 220 can also, for example, provide additional data storage capacity. The most common example of mass storage 220 is a hard disk drive. Mass storage 212, 220 generally store additional programming instructions, data, and the like that typically are not in active use by the processor 202. It will be appreciated that the information retained within mass storage 212 and 220 can be incorporated, if needed, in standard fashion as part of memory 210 (e.g., RAM) as virtual memory.

In addition to providing processor 202 access to storage subsystems, bus 214 can also be used to provide access to other subsystems and devices. As shown, these can include a display monitor 218, a network interface 216, a keyboard 204, and a pointing device 206, as well as an auxiliary input/output device interface, a sound card, speakers, and other subsystems as needed. For example, the pointing device 206 can be a mouse, stylus, track ball, or tablet, and is useful for interacting with a graphical user interface.

The network interface 216 allows processor 202 to be coupled to another computer, computer network, processor, chip (e.g. chip-to-chip link), or telecommunications network using a network connection as shown. For example, through the network interface 216, the processor 202 can receive information (e.g., data to be utilized to train an artificial neural network or data to be analyzed using the artificial neural network) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 202 can be used to connect the computer system 200 to an external network and transfer data according to standard protocols. For example, various process embodiments disclosed herein can be executed on processor 202, or can be performed across a network such as the Internet, intranet networks, or local area networks, in conjunction with a remote processor that shares a portion of the processing. Additional mass storage devices (not shown) can also be connected to processor 202 through network interface 216.

An auxiliary I/O device interface (not shown) can be used in conjunction with computer system 200. The auxiliary I/O device interface can include general and customized interfaces that allow the processor 202 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 2 is but an example of a computer system suitable for use with the various embodiments disclosed herein. Other computer systems suitable for such use can include additional or fewer subsystems. In addition, bus 214 is illustrative of any interconnection scheme serving to link the subsystems. Other computer architectures having different configurations of subsystems can also be utilized.

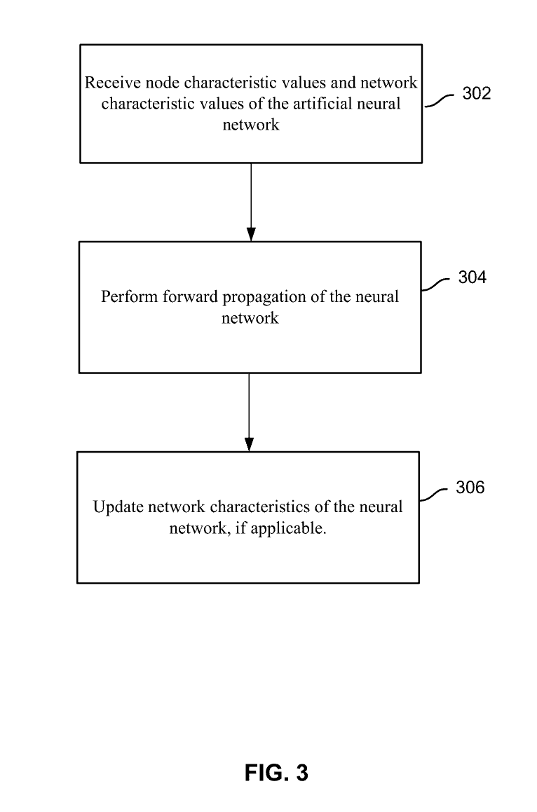

FIG. 3 is a flowchart illustrating an embodiment of a process for updating a state of an artificial neural network. In some embodiments, the process of FIG. 3 is at least in part implemented on processor 102 of FIG. 1 and/or system 200 of FIG. 2. The artificial neural network may be utilized to perform tasks such as classification, noise reduction, prediction, etc.

At 302, node characteristic values and network characteristic values of the artificial neural network are received. In artificial neural networks, nodes are connected together to form a network. In some embodiments, the nodes of the neural network represent artificial nodes that may be known as “neurons,” “neurodes,” “processing elements,” or “units.” The nodes of the neural network may represent input, intermediate, and output data and may be organized as input nodes, hidden nodes, and output nodes. The nodes may also be grouped together in various hierarchy levels. A node characteristic may represent data such as a pixel and other data processed using the neural network. The node characteristic values may be any value or parameter associated with a node of the neural network. Each node may be represented by an activation value (e.g., input value).

Each connection between the nodes (e.g., network characteristic) may be represented by a weight (e.g., numerical parameter determined in a training/learning process). In some embodiments, the connection between two nodes is a network characteristic and represents data dependencies between the connected nodes. The weight of the connection may represent the strength of the connection. In some embodiments, a node of one hierarchy grouping level may only connect to one or more nodes in an adjacent hierarchy grouping level. In some embodiments, network characteristic values include the weights of the connection between nodes of the neural network. The network characteristic values may be any value or parameter associated with connections of nodes of the neural network.

In some embodiments, receiving the node characteristic and weight characteristic values includes receiving activation values (e.g., node characteristic values) and weights (e.g., network characteristic values) for the neural network. For example, initial activation values of a first level of nodes and weights of connections between the nodes of different levels of the neural network are received. In some embodiments, the receiving the node characteristic and network characteristic values includes determining the node characteristic and network characteristic values. For example, one or more of the node characteristic and network characteristic values are initially randomly determined. In some embodiments, the received node characteristic values are input values of the neural network. In some embodiments, the received node characteristic and network characteristic values are values of a training set of data for the neural network. In some embodiments, the node characteristic and network characteristic values are provided as one or more matrices. For example, a first matrix of node characteristic values and a second matrix of network characteristic values are received. The matrices may specify the nodes in each node level and the connections between the nodes with its associated weight value for the neural network.

At 304, forward propagation of the neural network is performed. In some embodiments, performing forward propagation includes updating activation values of nodes of the neural network. For example for each activation value to be updated, a weighted sum of connected previous level activation nodes is determined and applied to a function (e.g., non-linear sigmoid function) to determine the updated activation value.

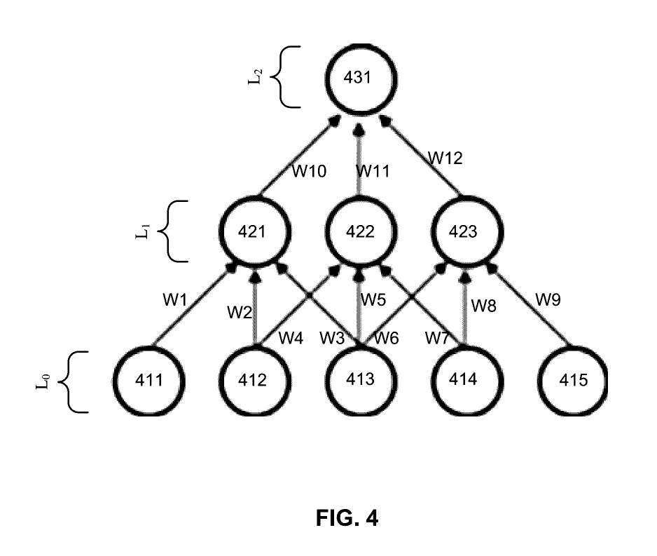

In the example neural network shown in FIG. 4, the first hierarchy layer grouping of nodes, L₀ nodes, includes nodes 411, 412, 413, 414, and 415. The second hierarchy layer grouping of nodes, L₁ nodes, includes nodes 421, 422, and 423. The third hierarchy layer grouping of nodes, L₂ nodes, includes node 431. The connections between the nodes each associated with weights (i.e., W1-W12) are shown. In one example, in 302, activation values of L₀ nodes and all weights shown (i.e., W1-W12) are received. In some embodiments, performing forward propagation includes determining activation values for L₁ nodes and then utilizing the L₁ activation values to determine the activation value for the L₂ node. Activation values for each successive level of nodes are updated sequentially. For example to perform forward propagation and update the activation value of node 421, a weighted sum of activation values of connected lower level L₀ nodes is determined (e.g., L₀ nodes 411, 412, and 413 are connected to node 421). In some embodiments, each of the activation values is multiplied by its corresponding weight value (e.g., connection to node 411 corresponds to W1, connection to node 412 corresponds to W2, and connection to node 413 corresponds to W3) before being added together. The weighted sum may be referred to as the pre-activation value. In order to determine the updated activation value (e.g., updated activation value of node 421), the pre-activation value is applied to a function (e.g., non-linear sigmoid function) to determine the updated activation value. The updated activation values for nodes 422 and 423 may be similarly determined. By multiplying the updated activation values of nodes 421, 422 and 423 by their corresponding weight, a weighted sum of these updated activation values may be applied to a non-linear function to determine the updated activation value for node 431. Although only three levels of nodes have been shown, additional or fewer levels may exist in other embodiments.

Returning to FIG. 3, in some embodiments, performing the forward propagation includes performing matrix operations. For example, a first matrix of node values for the nodes in each node level and a second matrix of weight values of the connections between the nodes are multiplied together to obtain a resulting matrix that represents the pre-activation values. Because matrix operations are often performed when processing artificial neural networks, specialized software/hardware instructions to handle matrix operations allow customizations and specializations that improve processing efficiency. Additionally, other specialized software/hardware to handle artificial neural networks may allow further efficiency improvements.

At 306, network characteristics of the neural network are updated, if applicable. For example, the artificial neural network is trained in an attempt to improve the accuracy of the neural network by modifying/updating the weights of the neural network. For example, the weights utilized to perform forward propagation may be modified to improve the artificial neural network. In some embodiments, the artificial neural network is initially trained using a training set to determine weights of the neural network. The training data may include input data (e.g., activation value(s) of the lowest node level of the neural network) and expected output data (e.g., expected activation value(s) of the highest node level of the neural network). In various embodiments, weights of the neural network are periodically and/or dynamically updated (e.g., weights of the neural network are updated until the stopping criteria have been met).

In some embodiments, backpropagation (e.g., backward propagation of errors) is utilized with an optimization method such as gradient descent to update the network characteristics. For example, a result of forward propagation (e.g., output activation value(s)) determined using training input data is compared against a corresponding known reference output data to calculate a loss function gradient. The gradient may be then utilized in an optimization method to determine new updated weights in an attempt to minimize a loss function. For example, to measure error, the mean square error is determined using the equation:

E=(target−output)²

To determine the gradient for a weight “w,” a partial derivative of the error with respect to the weight may be determined, where:

gradient=∂E/∂w

The calculation of the partial derivative of the errors with respect to the weights may flow backwards through the node levels of the neural network. Then a portion (e.g., ratio, percentage, etc.) of the gradient is subtracted from the weight to determine the updated weight. The portion may be specified as a learning rate “a.” Thus an example equation of determining the updated weight is given by the formula:

w_{new}=w_{old}−α∂E/∂w

The learning rate must be selected such that it is not too small (e.g., a rate that is too small may lead to a slow convergence to the desired weights) and not too large (e.g., a rate that is too large may cause the weights to not converge to the desired weights).

Traditionally it was believed that a high numerical precision with floating decimal points was desired when updating a neural network (e.g., when performing forward propagation or backpropagation) because otherwise the gradient would likely disappear (e.g., vanishing gradient problem) or become too large (e.g., exploding gradient problem). Additionally, it has been traditionally believed that it is desirable to be able to represent decimal values with great precision in deep neural networks to account for its many node levels and error gradients that decay exponentially. Thus in order to maintain a large dynamic range of fractional numbers that are able to be represented, values utilized when updating the neural network have been typically represented as floating point numbers. However, floating numbers utilize a relatively large number of bits to represent and involve complex and computationally expensive operations to process. This may contribute to power, bandwidth, scalability, computation, and storage inefficiencies.

However, the precision of a floating point number representation utilizing a large number of bits is likely not needed or even not desirable when updating the neural network. For example, with a large amount of training data and new ways of regularizing numbers, large floating point number representations may not be necessary when updating a neural network. Additionally, imprecision added by not utilizing large floating point number representations may be beneficial when updating neural networks to prevent overfitting of data (e.g., prevent neural network from representing random error/noise instead of the desired data relationship).

In some embodiments, rather than utilizing floating point number representations to represent values (e.g., activation values, weight values, intermediate values, etc.) of the neural network, fixed point number representations with varying decimal points (e.g., fixed number of digits after radix point) are utilized to maximize the dynamic range of numbers able to be represented using a fixed point number representation. By utilizing a fixed point number representation, a value may be represented using a smaller number of binary digits as compared to its traditional floating point number representation because the exponent is not stored with the number. In some embodiments, a fixed point number representation utilizing a smaller number of bits as compared to a traditional floating point number utilizing a larger number of bits is utilized. Although utilizing smaller number of bits may lead to a loss of precision in some computing contexts, it may not be material in the neural network context, and, in some cases, may be even beneficial to prevent overfitting. Additionally, saving in power consumption and processing resources may result from using fixed point number representations and/or representations utilizing a smaller number of bits (e.g., smaller numerical precision). In some embodiments, rather than using a single fixed point representation format with a single fixed number of digits after the radix point for all values of the neural network, each value of the neural network is able to be represented using different fixed point representation formats (e.g., each value may have a different number of fixed bits used to represent the number(s) after the radix point). By allowing variable fixed point representation formats, the amount of fractional precision able to be represented using the same number of total bits may be variably modified to dynamically achieve the desired amount of fractional precision and dynamic range of numbers able to be represented.

In some embodiments, a momentum factor is utilized to aid convergence when updating weights (e.g., may reduce the need for numerical precision and/or dynamic range). For example, the momentum factor acts as a low-pass filter by reducing rapid fluctuations of the gradient and keeps the direction of change of the updated weight more constant. When utilizing the momentum factor “β,” the following formulas may be utilized to determine an updated weight.

Δ_{new}=βΔ_{old}−α∂E/∂w_{old}

w_{new}=w_{old}+Δ_{new}

After network characteristics are updated (e.g., after backpropagation is performed), forward propagation is performed again using the updated weights and it is determined whether a stopping criteria have been met, if applicable. In some embodiments, determining whether the stopping criteria have been met includes comparing an output of the forward propagation (e.g., activation value(s) determined during forward propagation) with an expected output (e.g., expected activation value(s)). In some embodiments, performing the comparison includes determining whether a difference in values is within a specified range. In some embodiments, performing the comparison includes determining whether a determined error rate (e.g., least square error) is within a specified range.

If it is determined that the stopping criteria have not been met, backpropagation may be performed again. The cycle of performing backpropagation, forward propagation using the resulting weights of backpropagation, and testing for stopping criteria may be repeated until the stopping criteria have been met. If it is determined that the stopping criteria have been met, the process of FIG. 3 ends. For example, it is determined that the neural network has been successfully trained using provided training data because the stopping criteria have been met and training using the received data ends. In some embodiments, step 306 is not performed. For example, the neural network has been trained and in a current iteration of the process of FIG. 3, weights of the neural network are not to be updated and a result of the forward propagation in 304 is provided to end the process of FIG. 3. Although backpropagation is described in this embodiment to update weights of the neural network, in alternative embodiments, an algorithm other than backpropagation may be utilized to update weights of the neural network.

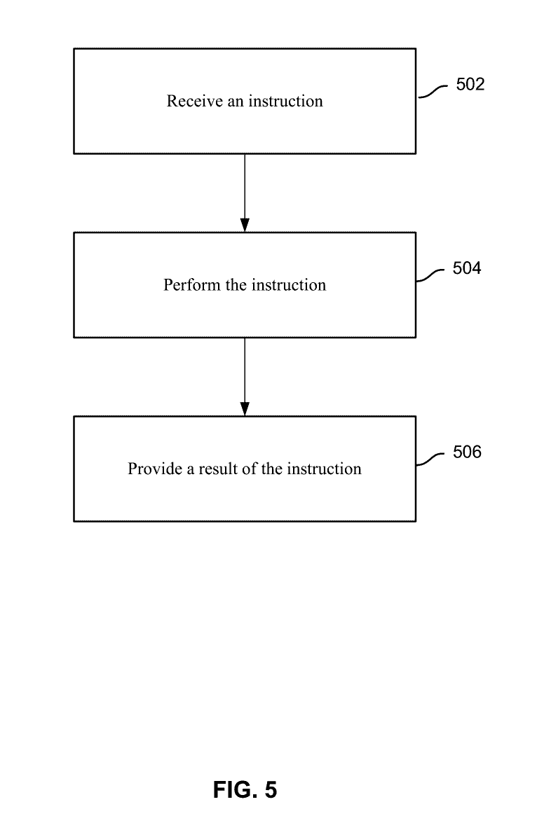

FIG. 5 is a flowchart illustrating an embodiment of a process for processing an instruction. In some embodiments, the process of FIG. 3 is at least in part implemented on processor 102 of FIG. 1 and/or system 200 of FIG. 2. In some embodiments, the instruction is processed using physical and/or virtual hardware components of processor 102 of FIG. 1. In some embodiments, at least a portion of the process of FIG. 5 is implemented in software.

At 502, an instruction is received. In some embodiments, the instruction is a software instruction. For example, an instruction of a programming language is received. In some embodiments, the instruction is a processor instruction. For example, an instruction from an instruction set of a hardware processor is received. In some embodiments, the instruction is an instruction of a processor that has been specially engineered to process artificial neural networks. In some embodiments, the instruction identifies an operation to be performed. For example, the instruction includes an operation code that identifies an operation to be performed. Examples of the types of operation to be performed may include a calculation (e.g., multiplication, division, addition, subtraction, etc.), matrix operation (e.g., matrix calculation, linear algebra operation, matrix transpose, etc.), data retrial/storage, data manipulation, and other operations to be performed on data of an artificial neural network. In some embodiments, the operation to be performed is a complex operation/instruction that includes a plurality of sub operations/instructions to be performed to complete the identified operation of the instruction.

In some embodiments, the instruction identifies one or more operands of an operation to be performed. For example, the storage location (e.g., processor register identifier) where an operand of the operation is stored is specified by the instruction. In some embodiments, the instruction identifies a decimal place location for one or more of the input and output operands. Each operand of the instruction may be formatted in a different fixed point representation format that specifies a different fixed number of bits after a radix point. For example, within the same number of binary bits that can be utilized to represent a value, the number of bits dedicated to representing digits after a radix point may be varied to accommodate the precision needed to represent the value. Thus, the value 0.1111111 (i.e., 7 bits after radix point) may be represented in fixed point representation with more binary digits after a radix point as compared to value 1111111.0 (i.e., 1 digit after radix point). By being able to vary the number of binary digits dedicated to representing digits after a radix point, a smaller total number of binary digits are able to represent a large range of values. In various embodiments, activation and weight values of the neural network are stored in storage/memory in various different fixed point representation formats associated with stored fixed format identifiers that identify the specific fixed point representation formats of the corresponding neural network value.

One example of the fixed point representation format identification specified by the instruction includes a specification of a fixed number of binary digits that represents a fractional component (e.g., number of the digits after a radix point). In some embodiments, the fixed point representation format identifies the number of bits before a radix point. In some embodiments, the fixed point representation format identifies a location of a radix point. In some embodiments, the fixed point representation format identifies that a bit is utilized to identify a sign (e.g., positive or negative) of the value. In some embodiments, the fixed point representation format identifies the total number of bits that are utilized to represent a value.

In some embodiments, a single specification of the fixed point representation format in the instruction identifies the fixed point representation format for all operands of the instruction. In some embodiments, the specification of the fixed point representation format is specified on a per operand basis and is specified for each operand. In some embodiments, a single operand identifies a grouping of a plurality of values and the specification of the fixed point representation format of the single operand specifies the fixed point representation format for the plurality of values of the grouping. For example, the operand identifies a matrix and the specification of the fixed point representation format for the matrix specifies the fixed point representation format for elements of the matrix. In various embodiments, the operand may be a single value, a matrix, a portion of a matrix, a vector, an array, a table, a list, and another single or grouping of values.

In some embodiments, the instruction identifies a location where a result of the operation of the instruction is to be stored. For example, a register identifier or other memory/storage location of where the result is to be stored is included in the instruction. In some embodiments, the instruction identifies a desired decimal point placement of the result of the operation. For example, the number of bits that are to be utilized to represent digits after a radix point, before the radix point, a positive/negative sign of the result, and/or the total number of bits to be utilized to represent the result is specified in the instruction as the fixed point representation format of the result. This may allow the result of the operation to be in the desired fixed point representation format that is different from the fixed point representation formats of the operands of the operation. In various embodiments, the result of the operation of the instruction may be a single value, a matrix, a portion of a matrix, a vector, an array, a table, a list, and another single or grouping of values. The desired fixed point representation format of the result may identify the fixed point representation format of one or more elements of the result.

In some embodiments, the total number of bits utilized to represent the value of each operand of the instruction (e.g., specified by a fixed point representation format identifier) may be different. In some embodiments, the total number of bits utilized to represent the value of each operand of the instruction must be the same despite being able to vary the number of bits that are utilized to represent the fixed number of digits after a radix point. In some embodiments, the total number of bits utilized to represent the value of the result of the instruction (e.g., specified by a fixed point representation format identifier) may be specified to be greater than, less than, or equal to the number of bits utilized to represent the value of an operand of the instruction.

At 504, the instruction is performed. For example, an operation identified by an operation code included in the instruction is performed. In some embodiments, performing the instruction includes performing each of a plurality of sub instructions/operations of the received instruction. In some embodiments, the intermediate results and/or operation operands of the sub instructions/operations are represented using a number of bits that is larger than the number of bits utilized to represent any value of the operands of the instruction received in 502. For example, when multiplying two 16 bit numbers in a sub instruction/operation, the resulting intermediate result value may be stored as a 32 bit value to retain the entire precision of the result. The intermediate result may be utilized as an operand of another sub operation of the instruction to determine another intermediate result value represented using a number of bits greater than the number of bits utilized to represent any value of the operands of the instruction received in 502.

Thus by representing the intermediate results and operands of the sub operations using the relatively larger number of bits, precision may be maintained as multiple sub operations are performed to process the instruction received in 502. For example, if the intermediate results were truncated/rounded to be represented using the same number of bits as the operands of the instruction received in 502, neural network performance problems may arise due to the loss of precision in intermediate results. Additionally the precision achieved by utilizing the relatively larger number of bits to represent the intermediate results of the sub operations allows the sub operations to be performed using fixed point number representations while maintaining sufficient precision and dynamic range as compared to utilizing floating point number representations. In one example, the instruction identifies a matrix multiplication to be performed and corresponding matrix elements are multiplied together in sub operations to determine intermediate results that are added together in other sub operations. The final intermediate result of the sub operations of the instruction may then be formatted (e.g., truncated) at the end to a desired fixed point representation format, allowing lower precision values to be provided/stored as a neural network parameters without sacrificing the benefits of utilizing higher precision numbers for intermediate sub operations of the instruction.

In some embodiments, the intermediate results are stored in a processor register that is larger in size as compared to registers that store operand values of the operation of the instruction. For example, a processor may include different sized hardware registers to store different types of values of the operation that require different numbers of bits to represent. In some embodiments, if a determined intermediate result cannot be represented in the total number of bits that are to be utilized to represent the intermediate result (e.g., number of bits required does not fit in an assigned register that is to store the value), the intermediate result may be truncated or rounded.

At 506, a result of the instruction is provided. In some embodiments, providing the result includes formatting an intermediate result of the instruction into a desired fixed point representation format. For example, as discussed previously, the desired fixed point representation format for the result is identified in the instruction. In some embodiments, a final intermediate result is formatted based on a truncation schema (e.g., rounded, truncated, or padded) to format the final intermediate result. For example, the result is to be represented using a smaller total number of bits as compared to the intermediate results of sub operations of the instruction and using a specified fixed number of bits to represent digits after a radix point. The digits after the radix point of the intermediate result may be truncated, rounded, or zero padded to the specified fixed number of bits to represent digits after the radix point, and digits before the radix point of the intermediate result may be zero padded to achieve the total number of desired bits. In some embodiments, truncating the intermediate value includes discarding bits beyond the desired number of bits. In some embodiments, truncating the intermediate value includes rounding by incrementing the last binary digit that has not been discarded if the immediately adjacent discarded binary digit was a “1” and not incrementing if it was a “0.”

The total number of bits of the formatted final result element may be larger or smaller than the number of bits utilized to represent a value of an operand of the instruction. In some cases, however, the final intermediate result may be too large in value (e.g., too large of a positive value or too large of a negative value) to be able to be represented in the desired fixed point representation format (e.g., due to overflow/saturation). For example, the number of bits assigned by the fixed point format to represent digits before a radix point may not include enough bits to represent value of the final intermediate result. In some embodiments, if the final intermediate result is too large in value to be able to be represented in the desired fixed point representation format, the result is formatted in the desired point representation format and set as the maximum value (e.g., maximum positive or negative value to match the sign of the final intermediate result) that can be represented using the desired fixed point representation format. In some embodiments, if the final intermediate result is too large in value to be able to be represented in the desired fixed point representation format, an error message is provided and the result is formatted in a format different from the initial desired fixed point representation format. In some embodiments, the providing the result includes storing the result to a processor register or other storage/location specified by the instruction. In various embodiments, the result may be provided as a result of a computer process, a program instruction, or a processor instruction.

In some embodiments, the desired fixed point representation format of the result has been determined and specified before the instruction is executed. The desired fixed point representation format may have been determined empirically. For example, one or more parameters of the desired fixed point representation format are determined based on one or more previous results of one or more previous processed instructions. In some embodiments, the typical range and frequency of values that are generated as a result of analyzing previous results associated with same/similar instructions, similar/same neural network, similar/same operation, similar/same operands, similar/same node/weight being updated, and any other parameter associated with previous instructions that have been processed are utilized to determine one or more parameters of the desired fixed point representation format. In some embodiments, rather than utilizing values in fixed point representation initially, the neural network has been updated using values in floating point representation to learn the profile of the type of instruction results being generated. The results of the floating point representation execution may be utilized to determine the optimal fixed point representation formats to be utilized. In some embodiments, a performance (e.g., an error rate, numbers of forward and backward propagations required to train, a result of a performance test performed using test input data to test a neural network model, Mean Absolute Error (MAE), Root Mean Squared Error (RMSE), percent good classification, etc.) of a neural network is tracked and utilized to determine a desired fixed point representation format for a similar future instruction. For example, if the neural network is performing poorly, the desired fixed point representation format may be adjusted.

In some embodiments, as instructions to update a neural network are being processed, instances when the result value becomes saturated (e.g., when the final intermediate result is too large in value to be able to be represented in the desired fixed point representation format) are tracked and utilized to determine a desired fixed point representation format for a similar future instruction. For example, the desired fixed point representation format for a next iteration of the instruction is selected to accommodate a larger value (e.g., number of bits after radix point reduced and number of bits before radix point increased). In some embodiments, in the event a result value becomes saturated, the instruction is performed again with a specification of a different desired fixed point representation until the result is not saturated.

In some embodiments, as instructions to update a neural network are being processed, instances when the result value results in underflow (e.g., when the final intermediate result is small in value (e.g., too many leading zeroes) to be efficiently represented in the desired fixed point representation format) are tracked and utilized to determine a desired fixed point representation format for a similar future instruction. For example, the desired fixed point representation format for a next iteration of the instruction is selected to accommodate a smaller value (e.g., number of bits after radix point increased and number of bits before radix point reduced). In some embodiments, in the event a result value results in underflow (e.g., detect too many leading zeroes), the instruction is performed again with a specification of a different desired fixed point representation until the result is satisfactory.

In some embodiments, an initial desired fixed point representation format is selected (e.g., initially based on historical data for same/similar instructions, neural network, operation, operands, node/weight being updated, other instruction parameter, etc.) and may be modified dynamically as the instruction is iteratively executed. For example, a desired fixed point representation format for the instruction may be tweaked over time as the same or similar instruction is processed again based on whether a previous iteration result saturated. In some embodiments, a Bayesian hyperparameter optimization or other dynamically learning algorithm is utilized to modify parameters of the desired fixed point representation as the instruction of the desired fixed point representation is executed over time.

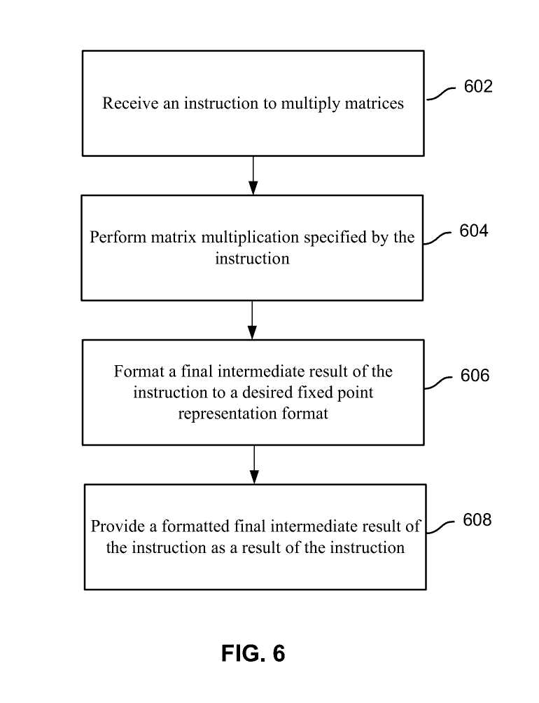

FIG. 6 is a flowchart illustrating an embodiment of a process for performing a matrix multiplication instruction. For example, a matrix multiplication is performed when updating an artificial neural network. In some embodiments, the process of FIG. 6 is at least in part implemented on processor 102 of FIG. 1 and/or system 200 of FIG. 2. In some embodiments, the matrix multiplication instruction is the instruction received and processed in the process of FIG. 5. In some embodiments, the instruction is processed using physical and/or virtual hardware components of processor 102 of FIG. 1. For example, the instruction is a native processor instruction of a computer processor designed for use in processing artificial neural networks. In some embodiments, at least a portion of the process of FIG. 6 is implemented in software.

At 602, an instruction to multiply matrices is received. For example, the instruction received in 502 is received. In some embodiments, an operation code or other operation identifier included in the instruction identifies that a matrix multiplication is to be performed. This operation code or identifier may indicate that the operands of the instruction should be interpreted as a matrix. In some embodiments, the instruction to perform the matrix multiplication specifies each identifier of a matrix or a portion of a matrix to be multiplied. For example, the matrix to be processed may have been divided into sub portions that will be multiplied separately and an instruction to multiply a portion of a matrix with another matrix portion is received. The matrix instructed to be multiplied may be a complete or a portion of a vector, one-dimensional matrix, two-dimensional matrix, other multi-dimensional matrix or any N-dimensional tensor. For example, the matrix multiplication instruction identifies a 32×32 matrix-matrix block to be multiplied. In some embodiments, the instruction may also specify for each matrix or a portion of a matrix to be multiplied a fixed point representation format of the elements of the matrix or matrix portion. For example, all the elements of each matrix or matrix portion operand are formatted in the same fixed point representation format and this fixed point representation format is specified in the instruction.

The fixed point representation format may specify the numbers of bits that are to be utilized to represent for an element value: digits after a radix point, digits before the radix point, a positive/negative sign, and/or the total number of bits. In one example, the matrix multiplication instruction identifies that two matrices, matrix “A” and matrix “B,” are to be multiplied (e.g., instruction identifies pointers to the matrices). The instruction also identifies in this example that matrix elements of Matrix “A” are formatted in a first fixed point representation format that specifies that each matrix element is represented in 16 binary bits total including one sign bit, three bits before the radix point, and twelve bits after the radix point. The instruction also identifies that matrix elements of Matrix “B” are formatted in a second fixed point representation format that specifies that each matrix element is represented in 16 binary bits total including one sign bit, zero bits before the radix point, and fifteen bits after the radix point. Although the sign-magnitude format has been utilized in the example, in other embodiments, a two's complement format may be utilized.

At 604, matrix multiplication specified by the instruction is performed. In some embodiments, performing the matrix multiplication includes performing one or more sub instructions and/or operations to perform the matrix multiplication. For example, performing matrix multiplication includes performing one or more sub instructions to multiply each element of a row from one matrix with a corresponding column element of another matrix. Then the results of the multiplications are added together using one or more other sub instructions/operations to determine an entry of a result matrix. Thus for each element of a result matrix to be calculated, a dot product of the corresponding row of a first matrix operand and column of a second matrix operand may be determined using one or more sub instructions and/or operations.

Multiplication of elements may be initially performed without regard to the location of their radix points because the radix point of the result may be determined after performing the multiplication. However, when element multiplication results are added together, the radix points of the element multiplication results may need to be aligned before being added together. In some embodiments, for each element of a result matrix to be calculated, first each element of a corresponding row from one matrix operand is multiplied with a corresponding column element of another matrix operand. Then a radix for each element multiplication result is determined and the radix points for the element multiplication results are aligned and summed together to determine the element of the result matrix. In some embodiments, the fixed point representation format is consistent across all elements within each matrix being multiplied and the radix point for the element multiplication results that are naturally aligned do not need to be explicitly aligned because the each element multiplication result is a result of multiplying elements with the same corresponding fixed point formats. For example, for each element of a result matrix to be calculated, first each element of a corresponding row from one matrix operand is multiplied with a corresponding column element of another matrix operand, then the element multiplication results are summed together without an explicit radix aligning step.

In some embodiments, intermediate results and values (e.g., sub operation results and operands) of performing the matrix multiplication instruction sub operations are represented using a number of bits that is larger than the number of bits utilized to represent values of the elements of the matrices being multiplied. In some embodiments, when multiplying two numbers, the maximum number of bits required to represent the result (e.g., also the number of bits required to avoid overflow/saturation) equals the sum of the number of bits utilized to represent the two numbers. For example, when multiplying two 16 bit numbers, the total number of bits required to represent the result is a 32 bit number. In some embodiments, the number of bits utilized to represent an intermediate result of an instruction is the sum of all of the numbers of bits utilized to represent the operand values of the instruction (e.g., excluding sign bits of the operand values, if applicable, plus an extra bit for a sign bit, if applicable). In some embodiments, an intermediate result is stored in a processor register that is larger in size as compared to registers that store operand values of the operation of the instruction. For example, a processor may include a 16 bit sized register(s) for operand values and a 37 bit sized register(s) for intermediate results of an instruction (e.g., 37 bit sized rather than 32 bit sized to accommodate additional operations performed using intermediate results). In some embodiments, the number of bits required to fully represent a result of the operation is more than the number of bits to be utilized to represent an intermediate result and the result is truncated/rounded before being stored in a processor register as the intermediate result.

At 606, a final intermediate result of the instruction is formatted to a desired fixed point representation format. The final intermediate result may be an intermediate result matrix that includes the elements to be formatted to produce the final result matrix. For example, the desired fixed point representation format for the result matrix is specified in the received matrix multiplication instruction.

In some embodiments, an element of the intermediate result matrix is formatted based on a truncation schema (e.g., rounded, truncated, or padded) to format the final intermediate result. For example, the formatted result element is to be represented using a smaller total number of bits as compared to the intermediate result and using a specified fixed number of bits to represent digits after a radix point. The digits after the radix point of the intermediate result may be truncated, rounded, or zero padded to the specified fixed number of bits to represent digits after the radix point, and digits before the radix point of the intermediate result may be zero padded to achieve the total number of desired bits. In some embodiments, truncating the intermediate value includes discarding bits beyond the desired number of bits. In some embodiments, truncating the intermediate value includes rounding by incrementing the last binary digit that has not been discarded if the immediately adjacent discarded binary digit was a “1” and not incrementing if it was a “0.” In some embodiments, a location of a radix point for elements of the final intermediate result matrix is determined prior to formatting to the desired fixed point representation format. For example, based on the fixed point representation formats of the operands of the instruction and the number of bits utilized to represent the final intermediate result matrix element, the location of the radix point is determined. The total number of bits of the formatted final result element may be larger or smaller than the number of bits utilized to represent a value of an operand of the instruction.

In some cases, however, the intermediate result element may be too large in value (e.g., too large of a positive value or too large of a negative value) to be able to be represented in the desired fixed point representation format (e.g., due to overflow/saturation). For example, the number of bits assigned by the fixed point format to represent digits before a radix point may not include enough bits to represent the value of the final intermediate result. In some embodiments, if the intermediate result element is too large in value to be able to be represented in the desired fixed point representation format, the final formatted result is formatted in the desired point representation format and set as the maximum value (e.g., maximum positive or negative value to match the sign of the final intermediate result) that can be represented using the desired fixed point representation format. In some embodiments, if the intermediate result element is too large in value to be able to be represented in the desired fixed point representation format, an error message is provided and the formatted result is formatted in a format different from the initial desired fixed point representation format.

By allowing sub operations of the matrix multiplication to be performed using higher precision numbers represented using higher numbers of bits as compared to the formatted (e.g., truncated) intermediate result, the benefits of utilizing higher precision numbers for intermediate sub operations of the instruction is not sacrificed while still allowing parameters of the neural network to be stored as lower precision values using smaller numbers of bits. For example, when processing an instruction to perform a 32×32 matrix-matrix multiplication, all or nearly all of the intermediate precision for all of multiply-add operations are maintained. After all intermediate operations have been completed, the truncation schema may be applied to the final intermediate results to achieve the desired output format. This allows fixed point numerical representations to be utilized instead of floating point numerical representations without significant drawbacks, allowing savings of power, performance and chip size.

At 608, a formatted final intermediate result of the instruction is provided as a result of the instruction. For example, a pointer to a memory location where a result matrix is stored is provided. In some embodiments, the providing the result includes storing the result to a processor register or other storage/location specified by the instruction. In various embodiments, the result may be provided as a result of a computer process, a program instruction, or a processor instruction.

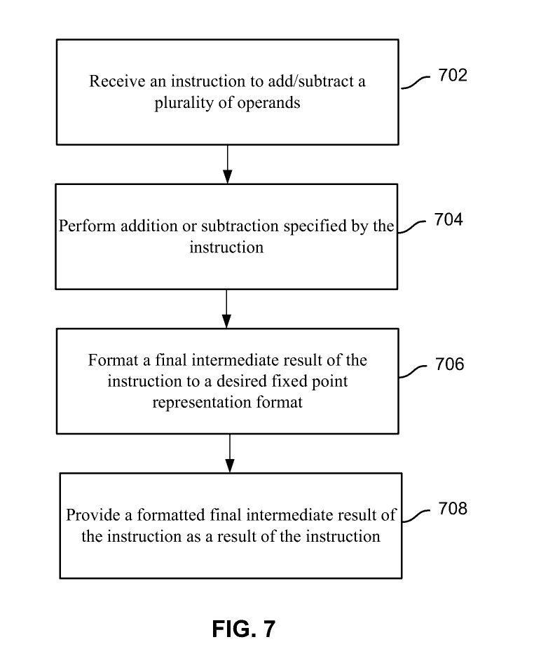

FIG. 7 is a flowchart illustrating an embodiment of a process for performing an addition or subtraction instruction. For example, the addition or subtraction instruction is performed when updating an artificial neural network. In some embodiments, the process of FIG. 7 is at least in part implemented on processor 102 of FIG. 1 and/or system 200 of FIG. 2. In some embodiments, the addition/subtraction instruction is the instruction received and processed in the process of FIG. 5. In some embodiments, the instruction is processed using physical and/or virtual hardware components of processor 102 of FIG. 1. For example, the instruction is a native processor instruction of a computer processor designed for use in processing neural networks. In some embodiments, at least a portion of the process of FIG. 7 is implemented in software.

At 702, an instruction to add/subtract a plurality of operands is received. For example, the instruction received in 502 is received. In some embodiments, an operation code or other operation identifier included in the instruction identifies that an addition operation is to be performed. In some embodiments, an operation code or other operation identifier included in the instruction identifies that a subtraction operation is to be performed. This operation code or identifier may indicate that the operands of the instruction should be interpreted as a matrix (or a portion of a matrix) and the instruction is a matrix add or subtraction instruction. In some embodiments, the instruction identifies the operand of the operation. In some embodiments, the instruction may also specify for each operand a fixed point representation format of the operand value. The operand may be a single value or a collection of values such as a matrix and an array.

The fixed point representation format may specify the numbers of bits that are to be utilized to represent for a value: digits after a radix point, digits before the radix point, a positive/negative sign, and/or the total number of bits of the value. In one example, the instruction identifies that two values “A” and “B” are to be added and value “A” is formatted in a first fixed point representation format that is represented in 16 binary bits total including one sign bit, three bits before the radix point, and twelve bits after the radix point, and value “B” is formatted in a second fixed point representation format that is represented in 16 binary bits total including one sign bit, zero bits before the radix point, and fifteen bits after the radix point. Although the sign-magnitude format has been utilized in the example, in other embodiments, a two's complement format may be utilized.

At 704, addition or subtraction specified by the instruction is performed. In some embodiments, performing the addition/subtraction operation includes performing one or more sub instructions and/or operations to perform the operation. For example, performing addition/subtraction includes performing one or more sub instructions to add or subtract each element of one matrix with a corresponding element of another matrix. When operands are added together or subtracted, the radix points of the operands are aligned before being added/subtracted. In some embodiments, the fixed point representation format is consistent across all elements within each matrix being added/subtracted.

In some embodiments, intermediate results and values of performing the addition/subtraction operation are represented using a number of bits that is larger than the number of bits utilized to represent the value of the operands. In some embodiments, when adding/subtracting two numbers, the maximum number of bits required to represent the result is the addition of the number of bits utilized to represent the two numbers. For example, when adding/subtracting two 16 bit numbers, the total number of bits required to represent the result is a 32 bit number. In some embodiments, the number of bits utilized to represent an intermediate result of an instruction is the sum of all of the number of bits utilized to represent the operand values of the instruction (e.g., excluding the sign bits of the operand values, if applicable, plus an extra bit for a sign bit, if applicable). In some embodiments, when adding/subtracting two values (e.g., numbers, vectors, matrices, etc.), the number of bits required to represent a result (e.g., intermediate result) without overflow/saturation is one more bit than the number of bits utilized to represent either operand. As more numbers are added/subtracted together (e.g., add together matrix element multiplication results), additional bits may be required for the intermediate result to prevent overflow/saturation. In some embodiments, an intermediate result is stored in a processor register that is larger in size as compared to registers that store operand values of the operation of the instruction. For example, a processor may include a 16 bit sized register(s) for operand values and a 37 bit sized register(s) for intermediate results of an instruction (e.g., 37 bit sized rather than 32 bit sized to accommodate additional operations performed using intermediate results). In some embodiments, the number of bits required to fully represent a result of the operation is more than the number of bits to be utilized to represent an intermediate result and the result is truncated/rounded before being stored in a processor register as the intermediate result.

At 706, a final intermediate result of the instruction is formatted to a desired fixed point representation format. The final intermediate result may be an intermediate result matrix that includes the elements to be formatted to produce the final result matrix. For example, the desired fixed point representation format for the result matrix is identified in the received instruction.

In some embodiments, the final intermediate result is formatted based on a truncation schema (e.g., rounded, truncated, or padded) to format the final intermediate result. For example, the formatted result element is to be represented using a smaller total number of bits as compared to the intermediate result and using a specified fixed number of bits to represent digits after a radix point. The digits after the radix point of the intermediate result may be truncated, rounded, or zero padded to the specified fixed number of bits to represent digits after the radix point, and digits before the radix point of the intermediate result may be zero padded to conform to the total number of desired bits. In some embodiments, truncating the intermediate value includes discarding bits beyond the desired number of bits. In some embodiments, truncating the intermediate value includes rounding by incrementing the last binary digit that has not been discarded if the immediately adjacent discarded binary digit was a “1” and not incrementing if it was a “0.”

In some cases, however, the intermediate result may be too large in value (e.g., too large of a positive value or too large of a negative value) to be able to be represented in the desired fixed point representation format (e.g., due to overflow/saturation). For example, the number of bits assigned by the fixed point format to represent digits before a radix point may not include enough bits to represent the value of the final intermediate result. In some embodiments, if the intermediate result is too large in value to be able to be represented in the desired fixed point representation format, the formatted result is formatted in the desired point representation format and set as the maximum value (e.g., maximum positive or negative value to match the sign of the final intermediate result) that can be represented using the desired fixed point representation format. In some embodiments, if the intermediate result is too large in value to be able to be represented in the desired fixed point representation format, an error message is provided and the formatted result is formatted in a format different from the initial desired fixed point representation format.

At 708, a formatted final intermediate result of the instruction is provided as a result of the instruction. In some embodiments, the providing the result includes storing the result to a processor register or other storage/location specified by the instruction. In some embodiments, a pointer to a memory location where a result matrix is stored is provided. In various embodiments, the result may be provided as a result of a computer process, a program instruction, or a processor instruction.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A processor for updating an artificial neural network, comprising:
a storage configured to represent a node characteristic using a fixed point node characteristic parameter and represent a network characteristic using a fixed point network characteristic parameter; and
a logic unit configured to:
operate on the fixed point node characteristic parameter and the fixed point network characteristic parameter to determine a fixed point intermediate parameter having a larger size than either the fixed point node characteristic parameter or the fixed point network characteristic parameter;
truncate a value associated with the fixed point intermediate parameter according to a system truncation schema; and
update the artificial neural network according to the truncated value.

2. The processor of claim 1, wherein the value is a result of a calculation operation performed based on one or more intermediate results of operating on the fixed point node characteristic parameter and the fixed point network characteristic parameter.

3. The processor of claim 2, wherein the result of the calculation operation and the intermediate results are fixed point numbers that are larger in size than either the fixed point node characteristic parameter or the fixed point network characteristic parameter.

4. The processor of claim 1, wherein the value is a result of performing a grouping of sub calculation operations of an instruction to operate on the fixed point node characteristic parameter and the fixed point network characteristic parameter.

5. The processor of claim 1, wherein the value is a result of performing a calculation operation using the fixed point intermediate parameter.

6. The processor of claim 1, wherein the value is the fixed point intermediate parameter.

7. The processor of claim 1, wherein the fixed point node characteristic parameter and the fixed point network characteristic parameter are represented using different fixed point representation formats.

8. The processor of claim 1, wherein the system truncation schema specifies a desired fixed point representation format of a result of the truncated value.

9. The processor of claim 1, wherein the operation on the fixed point node characteristic parameter and the fixed point network characteristic parameter to determine the fixed point intermediate parameter was initiated in response to a received processor instruction.

10. The processor of claim 9, wherein the processor instruction specifies the system truncation schema.

11. The processor of claim 9, wherein the processor instruction specifies a first fixed point representation format of the fixed point node characteristic parameter and a second fixed point representation format of the fixed point network characteristic parameter.

12. The processor of claim 9, wherein the system truncation schema was empirically determined at least in part based on a previous execution iteration of the received processor instruction.

13. The processor of claim 1, wherein the system truncation schema was determined at least in part based on a result of a previous update of the artificial neural network performed using floating point representations of the node characteristic and the network characteristic.

14. The processor of claim 1, wherein the system truncation schema was determined at least in part based on a result that a previous update of the artificial neural network resulted in overflow of a previously desired fixed point representation.

15. The processor of claim 1, wherein the system truncation schema was determined at least in part based on a result that a previous update of the artificial neural network resulted in an underflow of a previously desired fixed point representation.

16. The processor of claim 1, wherein the system truncation schema was determined at least in part based on a performance metric of the artificial neural network.

17. The processor of claim 16, wherein the performance metric includes a result of a performance test performed on the artificial neural network.

18. The processor of claim 1, wherein the system truncation schema is dynamically modified to specify a fixed number of bits that are to represent digits of the value associated with the fixed point intermediate parameter after a radix point.

19. The processor of claim 1, wherein operating on the fixed point node characteristic parameter and the fixed point network characteristic parameter to determine the fixed point intermediate parameter includes processing a processor instruction to perform matrix multiplication.

20. The processor of claim 19, wherein the value is an accumulation value of results of sub multiplication operations of the processor instruction to perform matrix multiplication.

21. The processor of claim 1, wherein the node characteristic includes an activation node of the artificial neural network.

22. The processor of claim 1, wherein the network characteristic includes a node connection weight of the artificial neural network.

23. The processor of claim 1, wherein updating the artificial neural network includes updating the node characteristic or the network characteristic using the truncated value.

24. The processor of claim 1, wherein a total number of bits of the truncated value is not equal to a total number of bits of the fixed point node characteristic parameter or the fixed point network characteristic parameter.

25. A method of updating an artificial neural network, comprising:
representing a node characteristic using a fixed point node characteristic parameter;
representing a network characteristic using a fixed point network characteristic parameter;
using a processor to operate on the fixed point node characteristic parameter and the fixed point network characteristic parameter to determine a fixed point intermediate parameter having a larger size than either the fixed point node characteristic parameter or the fixed point network characteristic parameter;
truncating a value associated with the fixed point intermediate parameter according to a system truncation schema; and
updating the artificial neural network according to the truncated value.

26. A computer program product for updating an artificial neural network, the computer program product being embodied in a non-transitory computer readable storage medium and comprising computer instructions for:
representing a node characteristic using a fixed point node characteristic parameter;
representing a network characteristic using a fixed point network characteristic parameter;
operating on the fixed point node characteristic parameter and the fixed point network characteristic parameter to determine a fixed point intermediate parameter having a larger size than either the fixed point node characteristic parameter or the fixed point network characteristic parameter;
truncating a value associated with the fixed point intermediate parameter according to a system truncation schema; and
updating the artificial neural network according to the truncated value.
